(19) United States
(12) Patent Application Publication
(10) Pub. No.: US 2002/0095309 A1
(43) Pub. Date: Jul. 18, 2002

(54) System and method for dispensing cosmetics products

(76) Inventor: Joanna Rothschild, New Rochelle, NY (US)

Correspondence Address: Joanna Rothschild., 1273 North Avenue #6B6, New Rochelle, NY, 10804, US

(21) Appl. No.: 10/010,157

(22) Filed: Nov. 8, 2001

Related U.S. Application Data
(60) Provisional application No. 60/251,529, filed on Dec. 5, 2000.

(51) Int. Cl. G06F 17/60

(52) U.S. Cl. 705/1

(57) ABSTRACT

A device for dispensing at least one cosmetics product to a user. The device includes a payment receipt means receive and process payment information from the user. A product display means displays to a user the cosmetics product or products which are available. A product selection means enables a user to select a cosmetics product. A product storage means stores the cosmetics products in the device, and a product delivery means delivers a selected product to the user upon the user selecting the cosmetics product desired to be dispensed and upon the receipt of sufficient payment via the payment receipt means. The device may also include an automatic product selection feature employing an appearance data collection means configured to collect and transmit data corresponding to the user's appearance, and an automatic product selection means configured to receive the data and automatically select at least one cosmetics product for delivery to the user.

### RELATED APPLICATIONS

This application claims the benefit of priority of Applicant's co-pending U.S. Provisional Patent Appl. Serial No. 60/251,529 filed on Dec. 5, 2000.

### FIELD OF THE INVENTION

The present invention relates generally to vending machines, and more particularly to a system and method for dispensing cosmetics products.

### BACKGROUND OF THE INVENTION

In today's image-conscience society, people are more aware than ever of the importance of their appearance. Numerous studies have demonstrated that a person's success is related to his or her appearance. Many people are aware of this correlation, and spend the time, effort and money necessary to improve the image that they present to others. Many others are not inspired by a desire for success, but rather seek to look their best for their own satisfaction. Whatever the reason, the cosmetics industry (for the purposes of this application, the terms “cosmetics” or “cosmetics products” are intended to include any and all make-up, beauty and health products) sells billions of dollars worth of cosmetics products to people interested in improving their appearance.

Traditionally, cosmetics products are applied by a person before a particular event. Naturally, the person applies the cosmetics products in a manner which is appropriate for the event. One such event may be simply going to work, and the person may apply his or her cosmetics products in a manner which is appropriate for the workplace. For instance, for a businesswoman who is in contact with corporate clients, it may be appropriate to apply cosmetics products having a subtle color or style so as to convey a professional appearance. Alternatively, for a saleswoman in a clothing boutique, it may be appropriate to apply cosmetics products having a more vibrant color or style, so as to convey a more fashionable appearance.

Another such event which may warrant the application of cosmetics products is a social gathering or party. In this context also, the type of social gathering or party that is attended may require the application of different styles or colors of cosmetics products. For instance, a dinner with friends may call for the subtle application of cosmetics products, while a formal event such as a wedding may call for a more glamorous or ostentatious appearance.

Usually, a person keeps his or her largest supply of cosmetics products at home, and applies at home those cosmetics products that are deemed appropriate for the day's anticipated events. Some people also carry (e.g.—in a purse) a select few of these cosmetics products to be applied throughout the day. Usually, the select few cosmetics products which are carried around are the same as those which have been applied at home, in anticipation of the original application needing to be re-touched, or else are those cosmetics products that are appropriate for an event planned for later in the day.

However, despite the best planning, it is inevitable that a person will be in a public place and find that they do not have on hand the cosmetics product that they want to apply. Whether due to forgetfulness, lack of time, a change of plans, etc., there are countless situations in which this may occur. It is very unlikely that a person is able to consistently and accurately anticipate the cosmetics products that he or she will need throughout the day. Furthermore, even if some people are able to consistently and accurately anticipate the cosmetics products that will be needed throughout the day, these people may not want to be burdened with carrying around a supply of cosmetics products.

Therefore, there exists a need for an improved system and method for dispensing cosmetics products.

### SUMMARY OF THE INVENTION

The present invention, in accordance with one example embodiment thereof, relates to a device for dispensing at least one cosmetics product to a user. The device comprises a payment receipt means, such as a coin or bill slot or a debit or credit card reader, configured to receive and process payment information from the user. A product display means, such as windows in a front cover of the device through which the user can view the cosmetics products or a picture of a cosmetics product, is configured to display to a user the cosmetics product or products which are available to be selected and dispensed from the device. A product selection means (e.g., buttons pressable by the user) is configured to enable a user to select a cosmetics product which the user desires to be dispensed. A product storage means stores the cosmetics products in the device, and a product delivery means is configured to deliver a selected product to the user upon the user selecting the cosmetics product desired to be dispensed and upon the receipt of sufficient payment via the payment receipt means.

According to another embodiment of the invention, the device also includes an automatic product selection feature. The automatic product selection feature employs an appearance data collection means configured to collect and transmit data corresponding to the user's appearance, and an automatic product selection means configured to receive the data and automatically select at least one cosmetics product for delivery to the user. The appearance data collection means may comprise at least one of an interactive keyboard, punchpad and touch-screen which the user presses to enter data corresponding to the user's appearance. Alternatively, or in conjunction with the interactive keyboard, punchpad or touchscreen, the appearance data collection means may also comprise a camera configured to view the user and to collect and transmit visual data corresponding to the user's appearance. When the camera is employed, the automatic product selection means is configured to receive the visual data and to analyze it in order to automatically select a cosmetics product for delivery to the user. The appearance data collection means may be configured to receive data from the user corresponding to a current appearance of the user, a desired appearance of the user, or both.

### BRIEF DESCRIPTION OF THE DRAWINGS

The present invention will be further understood from the following description with reference to the accompanying drawings, in which:

FIG. 1 is a block diagram that illustrates the various components of a cosmetics product dispensing device, in accordance with one embodiment of the invention;

FIG. 2 is an illustration of a product display means which may be employed in order to display to a user the products which are available to be selected, in accordance with one embodiment of the invention;

FIG. 3 is a flowchart that illustrates the operation of a selection verification means in the event that a user pays for a product with cash, in accordance with one embodiment of the invention;

FIG. 4 is a flowchart that illustrates the operation of the selection verification means in the event that a user pays for a product with a credit card, in accordance with another embodiment of the invention;

FIG. 5 is a block diagram that illustrates the various components of a cosmetics product dispensing device that automatically selects and delivers products to a user, in accordance with still another embodiment of the invention.

### DETAILED DESCRIPTION OF THE INVENTION

According to one embodiment of the invention, the present invention is directed to a device which is configured to dispense cosmetics products. As previously mentioned, for the purposes of this application, the term “cosmetics products” is intended to include all makeup, beauty and health products.

Preferably, the device of the present invention is configured to be installed in publicly-accessible locations. Ideally, the publicly-accessible locations are selected as those locations in which a person is most likely to be in need of a desired cosmetics product. For instance, these locations may include, but are not limited to, restaurants, office buildings, nightclubs, airports, train stations, health clubs, etc. Of course, there is no limit to the number or type of locations that a device of the present invention may be employed, and the present invention is not intended to be limited in scope by those locations discussed herein.

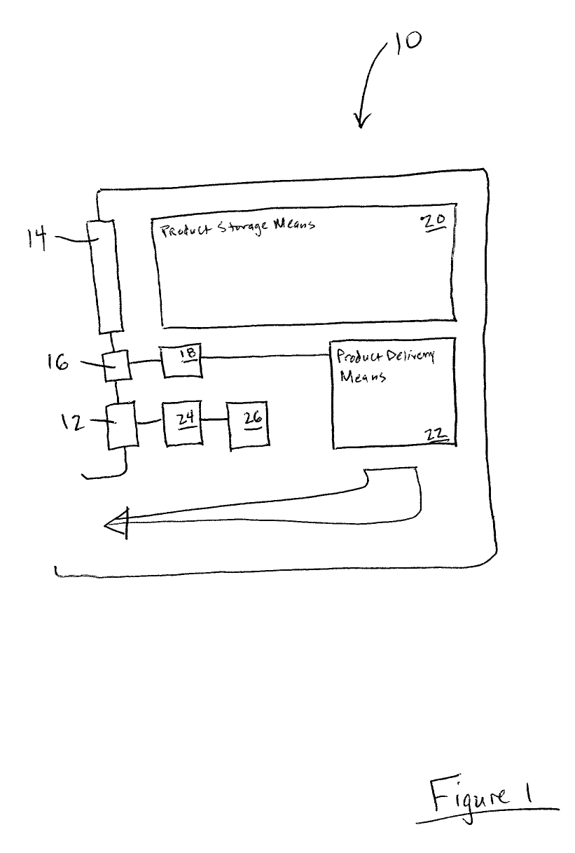

In the preferred embodiment, the present invention is directed to a device which is configured to dispense at least one, but preferably a variety of, selectable cosmetics products. The device operates as a vending machine, by dispensing to the user a selected product upon receiving from the user a sufficient payment. FIG. 1 is a block diagram that illustrates, according to one embodiment of the invention, the various components of device 10.

For instance, device 10 comprises a payment receipt means 12. Payment receipt means 12 is configured to receive and process payment information from a user. Payment receipt means 12 may be a coin slot which is configured to receive coins, or a bill slot, which is configured to receive dollar bills. Alternatively, payment receipt means 12 may be a credit card or debit card reader which is configured to read credit card account information or debit card account information, respectively, when a card is swiped therethrough. Payment receipt means 12 may also comprise a keypad or the like for a user to enter credit card account information or debit card account information. Of course, there is no limit to the type of payment receipt means 12 that may be employed, and the present invention is not intended to be limited in scope by those types discussed herein.

Device 10 also comprises product display means 14. Product display means 14 displays to a user the cosmetics products which are available to be selected and dispensed from the machine. Product display means 14 may comprise windows in the front cover of device 10 through which a user can view a product. Alternatively, product display means 14 may comprise pictures or other visual representations of a product which may be selected by the user.

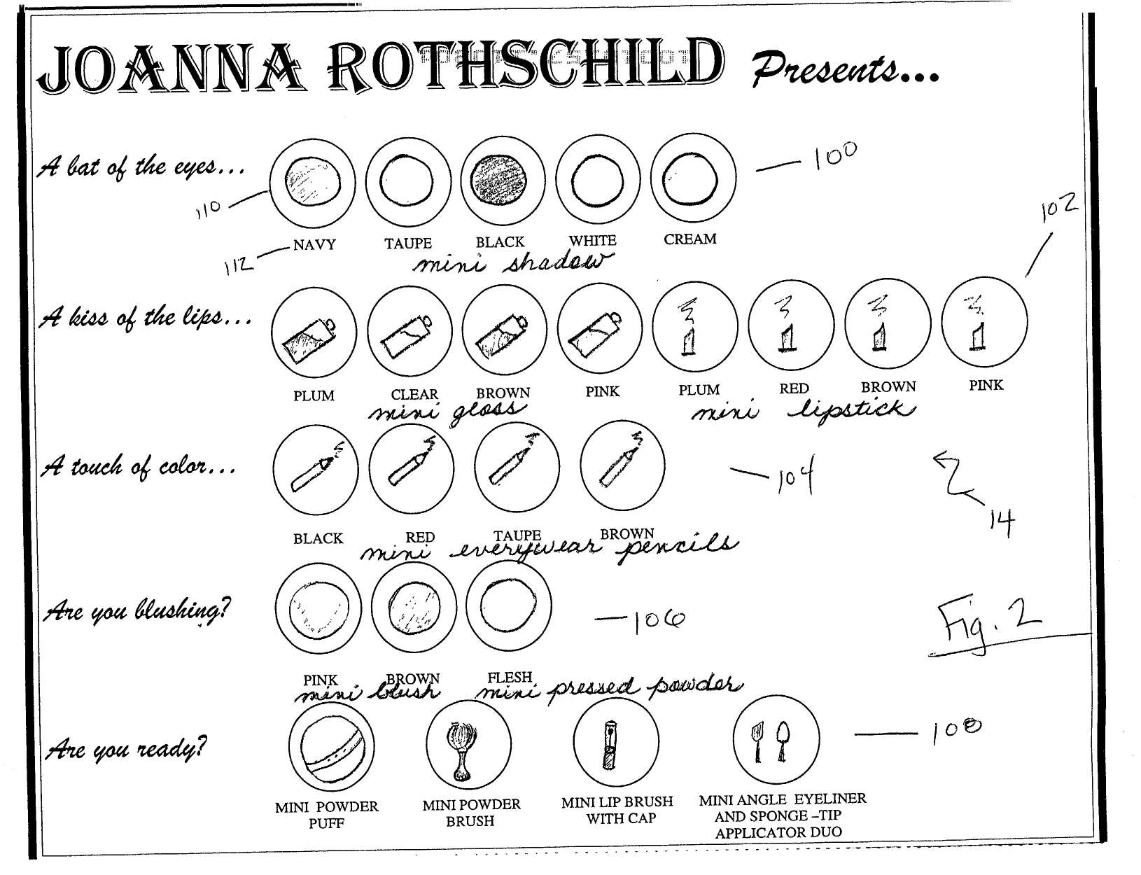

For example, FIG. 2 is an illustration of product display means 14 which may be employed by the present invention in order to display to a user the products which are available to be selected. FIG. 2 shows several rows of products, such as row 100 having various shades of eye shadow. Each shade has a display picture, such as display picture 110, which shows the shade of the eye shadow, and a description, such as shade description 112, which states the shade of the eye shadow. FIG. 2 also shows row 102, having various shades of lip glosses and lipsticks and row 104 having various shades of eyeliner pencils. Row 106 has several shades of blush powder, while row 108 has application tools such as a powder puff, powder brush, etc. Of course, there is no limit to the type of product display means 14 that may be employed, and the present invention is not intended to be limited in scope by the arrangement shown here, nor the specific types of products or shades that are discussed herein.

Device 10 may also comprise a product selection means 16. Product selection means 16 is configured to enable a user to select the product or products which the user desires to be dispensed. Product selection means 16 may be buttons that are adjacent to the display windows or pictures that are shown in product display means 14 of FIG. 2. Alternatively, the windows or pictures that are shown in product display means 14 of FIG. 2 may be pressable, and a user presses the window or picture corresponding to the desired product. Product selection means 16 may also comprise a keyboard or punchpad for a user to enter a code associated with the desired product, or else a touch screen configured to enable a user to do the same. Of course, there is no limit to the type of product selection means 16 that may be employed, and the present invention is not intended to be limited in scope by those types discussed herein.

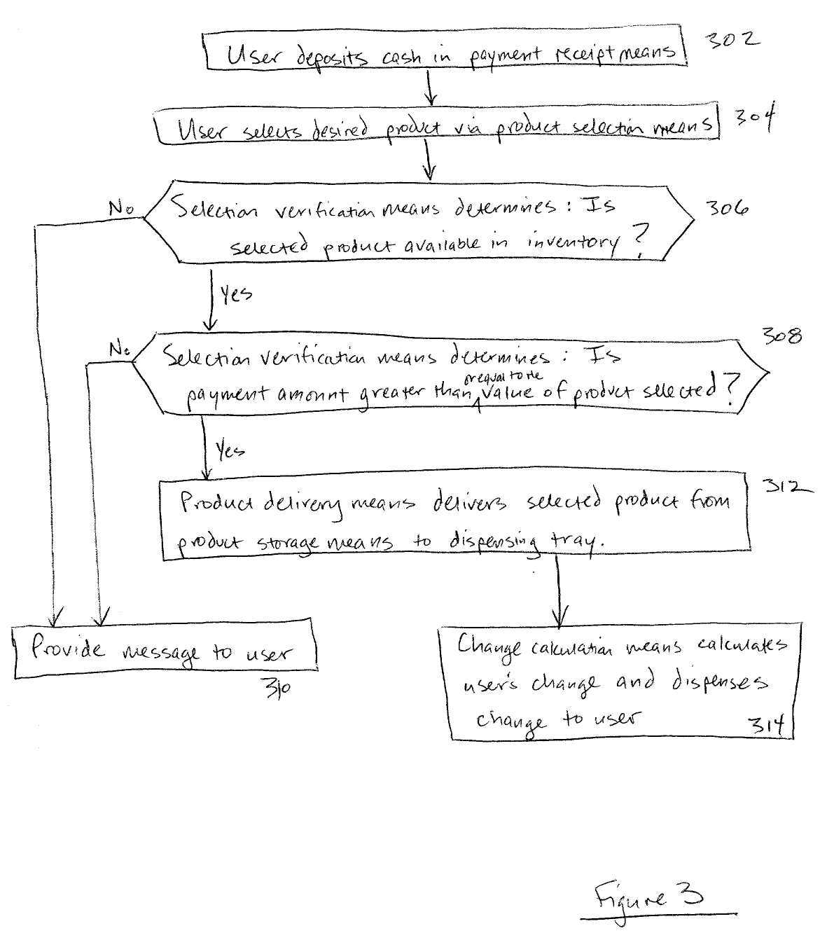

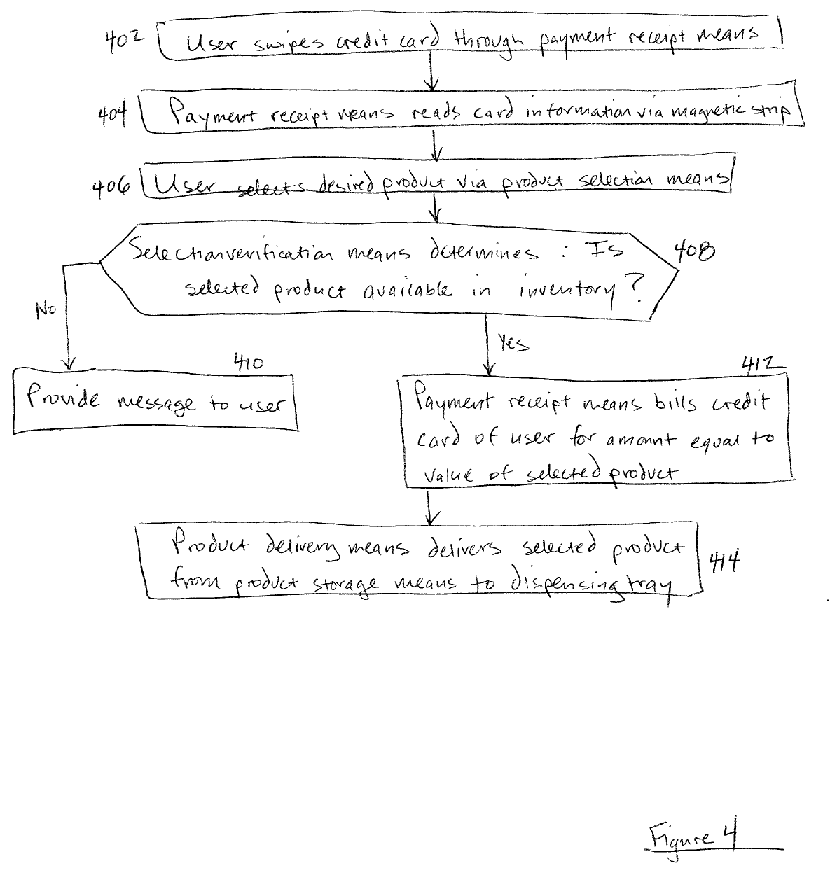

Device 10 may also comprise a selection verification means 18. Selection verification means 18 is configured to determine that the selection made by the user is valid, that the product selected is available (e.g.—currently stored in device 10), and that the user has provided sufficient finds to pay for the product selected. It is noted that, while selection verification means 18 and other features of device 10 are described as separate modules, it is understood that the functions performed by device 10 (such as processing selections, verifying selections, etc.) may be performed by a single processor, or by any combination of hardware and software. FIG. 3, which is explained in greater detail below, is a flowchart that illustrates the operation of selection verification means 18 in the event that a user pays for a product with cash. FIG. 4, which is also explained in greater detail below, is a flowchart that illustrates the operation of selection verification means 18 in the event that a user pays for a product with a credit card.

Device 10 may also comprise a product storage means 20. Product storage means 20 is configured to store products, such as in compartments or slots internal to device 10. Device 10 may also comprise a product delivery means 22. Product delivery means 22 is configured to deliver a selected product to a user. Product delivery means 22 may be any mechanical device, such as a belt, motor, lever, rotating screw, etc. which moves a selected product from product storage means 20 into position for a user to retrieve. Product delivery means 22 may also comprise a slot for a selected product to fall or slide, and a dispensing tray for the user to receive the dispensed product.

Device 10 may also comprise a change calculation means 24. Change calculation means 24 is configured to calculate the change which is due to a user upon dispensing a selected product. As previously noted, while change calculation means 24 is described as separate module, it is understood that the functions performed by change calculation means 24 may be performed by a single processor, or by any combination of hardware and software. As explained in FIG. 3 below, in a cash transaction, change calculation means 24 is configured to calculate the change owed to the user by subtracting the value of the product selected from the payment amount received by payment receipt means 12.

Device 10 may also comprise a change delivery means 26. Change delivery means 26 may comprise, according to one embodiment of the invention, a reservoir of coins, bills, tokens or the like, which are delivered to a user by change delivery device 26. The coins, bills or tokens may be delivered to the user via the same tray that the user retrieved the selected product from, or else device 10 may employ a separate dispensing tray for the user's change.

As previously mentioned, FIG. 3 is a flowchart that illustrates the operation of selection verification means 18 in the event that a user pays for a product with cash. At step 302, a user deposits cash into payment receipt means 12. At step 304, the user selects a desired product via product selection means 16.

At step 306, selection verification means 18 determines whether the product selected by the user is available in inventory by checking product storage means 20. If selection verification means 18 determines that the product selected by the user is available in inventory, then device 10 proceeds to step 308. If selection verification means 18 determines that the product selected by the user is not available in inventory, then device 10 proceeds to step 310, at which a message is provided to the user, such as “OUT OF STOCK”.

At step 308, selection verification means 18 determines whether the payment amount received by payment receipt means 12 is greater than or equal to the value of the product selected. If selection verification means 18 determines that the payment amount received by payment receipt means 12 is greater than or equal to the value of the product selected, then device 10 proceeds to step 312. If selection verification means 18 determines that the payment amount received by payment receipt means 12 is less than the value of the product selected, then device 10 proceeds to step 310, at which a message is provided to the user, such as “INSERT ADDITIONAL FUNDS”.

At step 312, product delivery means 22 delivers the selected product from product storage means 20 to the dispensing tray. At step 314, change calculation means 24 calculates the user's change and dispenses the appropriate amount of change to the user.

FIG. 4, on the other hand, is a flowchart that illustrates the operation of selection verification means 18 in the event that a user pays for a product with a credit card. At step 402, a user swipes his or her credit card through payment receipt means 12. It is noted that the user may instead swipe a debit card, gift card or any other type of card having a magnetic strip that stores information corresponding to the user or an account of the user. At step 404, payment receipt means 12 reads the information from the card's magnetic strip. At step 406, the user selects a desired product via product selection means 16.

At step 408, selection verification means 18 determines whether the product selected by the user is available in inventory by checking product storage means 20. If selection verification means 18 determines that the product selected by the user is available in inventory, then device 10 proceeds to step 412. If selection verification means 18 determines that the product selected by the user is not available in inventory, then device 10 proceeds to step 410, at which a message is provided to the user, such as “OUT OF STOCK”.

At step 412, payment receipt means 12 bills the credit card of the user in the amount of the value of the selected product. The manner in which a credit card is billed is well known in the art, and is therefore not discussed in detail herein. At step 414, product delivery means 22 delivers the selected product from product storage means 20 to the dispensing tray.

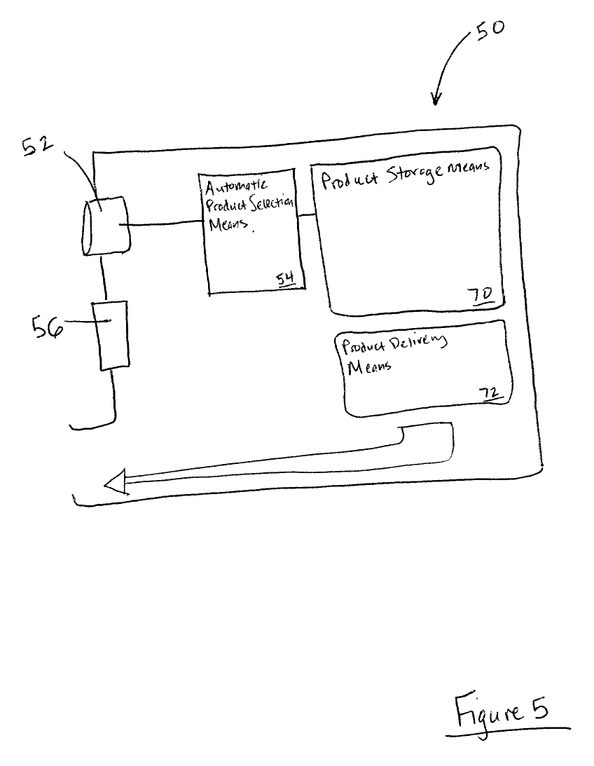

According to still another embodiment, the device of the present invention comprises a automatic product selection feature. FIG. 5 is a block diagram that shows the salient features of device 50 which operates similarly to device 10 shown in FIG. 1, but which further employs an appearance data collection means 52 and an automatic product selection means 54. Appearance data collection means 52 collects data corresponding to the user's appearance, and transmits the data to automatic product selection means 54. Once automatic product selection means 54 receives the data corresponding to the user's appearance, automatic product selection means 54 is configured to automatically select appropriate products and deliver them to the user.

Appearance data collection means 52 may comprise an interactive keyboard, punchpad or touch-screen which the user may press to enter data corresponding to his or her appearance. For instance, in one embodiment, the user presses a button in order to select an eyeshadow. Device 10 may then request that the user enter data corresponding to the user's appearance by inputting his or her eye color via appearance data collection means 52. Once the requested data is inputted, automatic product selection means 54 then automatically selects and delivers to the user an eye shadow product having a color which is predetermined to enhance that particular user's eye color.

Alternatively, appearance data collection means 52 may comprise a camera which is configured to view a user and to collect visual data corresponding to the user's appearance. For instance, the camera may collect visual data such as the uset's eye color, hair color, skin color or texture, facial structure, etc. Once this data is transmitted to automatic product selection means 54, it may be analyzed in order for automatic product selection means 54 to automatically select and deliver the appropriate cosmetics products.

For instance, if the camera of appearance data collection means 52a collects and transmits visual data corresponding to a user having fair skin, green eyes and red hair, automatic product selection means 54 is configured to automatically select and deliver to the user a product of a color or style that is predetermined to enhance the user's unique appearance. Similarly, if the camera of appearance data collection means 52a collects and transmits data corresponding to a user that has blunt features, automatic product selection means 54 is configured to automatically select and deliver to the user a blush that is predetermined to help define or accentuate the user's cheekbones.

In one embodiment, appearance data collection means 52 comprises both a camera and an input device such as a keyboard, punchpad or touch-screen. In this embodiment, automatic product selection means 54 is configured to receive visual data from the camera as well as data inputted by the user. For instance, upon appearance data collection means 52 collecting and transmitting data corresponding to the user's appearance, the user may enter a selection for a specific type of product (e.g.—a lipstick). Automatic product selection means 54 is then configured to automatically select and deliver to the user the color of lipstick which is the most appropriate for the user taking into consideration the user's appearance.

The present invention also contemplates that the user may input, via appearance data collection means 52, data corresponding to an appearance that the user desires to obtain, rather than data corresponding to the appearance which the user already has. For instance, in one embodiment, the user inputs a selection from several appearance types, such as “Professional”, “Evening—Casual”, “Evening—Formal”, “Gothic”, etc. Based on the selection inputted by the user, automatic product selection means 54 automatically selects and delivers products to the user which will enable the user to achieve the desired appearance.

In still another embodiment, appearance data collection means 52 collects and transmits to automatic product selection means 54 data corresponding to an appearance that the user desires to obtain and data corresponding to the appearance which the user already has. Thus, in this embodiment, automatic product selection means 54 receives the user's inputted selection of a desired appearance (from several appearance types, such as “Professional”, “Gothic”, etc.) as well as visual data from the camera or inputted data corresponding to the user's current appearance. Based on the data inputted by the user and the visual data collected by a camera, automatic product selection means 54 automatically selects and delivers products to the user which will enable the user to achieve the desired appearance.

Thus, the present invention may be employed to perform the same functions as a cosmetics products salesperson. Specifically, a cosmetics products salesperson delivers to a person one or more requested cosmetics products. The present invention, according to various embodiments, performs this function with additional convenience to a user and without the additional expense of employing the cosmetics products salesperson. In addition, a cosmetics products salesperson evaluates a person's appearance and recommends cosmetics products that will enhance that person's appearance. Those embodiments described above that employ an appearance data collection feature and an automatic product selection feature perform a similar function, again with additional convenience to the user and without the additional expense of employing the cosmetics products salesperson.

While there has been shown and described particular embodiments of the invention, it will be obvious to those skilled in the art that changes and modifications can be made therein without departing from the invention, and therefore, it is understood that all such changes and modifications fall within the true spirit and scope of the invention.

I claim:

1. A device for dispensing a cosmetics product to a user, comprising:
payment receipt means configured to receive and process payment information from the user;
product display means configured to display to a user the cosmetics product which is available to be selected and dispensed from the device;
product selection means configured to enable a user to select the cosmetics product which the user desires to be dispensed;
product storage means configured to store the cosmetics product in the device;
product delivery means configured to deliver the selected cosmetics product to the user upon the user selecting the cosmetics product desired to be dispensed and upon the receipt of sufficient payment via the payment receipt means.

2. The device of claim 1, wherein the device further comprises a selection verification means coupled to the payment receipt means, the product storage means and the product selection means, wherein said selection verification means is configured to determine that the selection made by the user is valid, that the product selected is available in the product storage means, and that the user has provided sufficient funds via the payment receipt means to pay for the product selected.

3. The device of claim 1, wherein the device further comprises:
a change calculation means configured to calculate the change which is due to a user upon dispensing a selected product;
change delivery means configured to deliver to the user the change calculated by the change calculation means.

4. The device of claim 1, wherein the payment receipt means is a slot for receiving at least one of coins and bills.

5. The device of claim 1, wherein the payment receipt means is a card reader configured to read at least one of credit card account information and debit card account information when a card is swiped therethrough.

6. The device of claim 1, wherein the payment receipt means is a keypad for a user to enter at least one of credit card account information and debit card account information.

7. The device of claim 1, wherein the product display means comprises windows in a front cover of the device through which the user can view the cosmetics product.

8. The device of claim 1, wherein the product display means comprises at least one of a picture and a visual representation of the cosmetics product.

9. The device of claim 1, wherein the product selection means comprises buttons adjacent to the product display means.

10. The device of claim 1, wherein the product selection means is actuable by the user pressing on the product display means.

11. The device of claim 1, wherein the product selection means comprises a keypad for the user to press a code associated with the cosmetics product.

12. The device of claim 1, further comprising an automatic product selection feature including:
an appearance data collection means configured to collect data corresponding to the user's appearance, and to transmit the data; and
an automatic product selection means configured to receive the data and automatically select the cosmetics product for delivery to the user.

13. The device of claim 12, wherein the appearance data collection means comprises at least one of an interactive keyboard, punchpad and touch-screen which the user may press to enter data corresponding to the user's appearance.

14. The device of claim 12, wherein the appearance data collection means comprises a camera configured to view the user and to collect and transmit visual data corresponding to the user's appearance.

15. The device of claim 14, wherein the automatic product selection means is configured to receive the visual data and to analyze it in order to automatically select a cosmetics product for delivery to the user.

16. The device of claim 12, wherein the appearance data collection means is configured to receive data from the user corresponding to a current appearance of the user.

17. The device of claim 12, wherein the appearance data collection means is configured to receive data from the user corresponding to a desired appearance of the user.

18. The device of claim 12, wherein the appearance data collection means is configured to receive data from the user corresponding to a current appearance of the user and to receive data from the user corresponding to a desired appearance of the user.

19. A method for dispensing a cosmetics product to a user, comprising the steps of:
receiving and processing via a payment receipt means of a dispensing device payment information from the user;
displaying to the user via a product display means the cosmetics product which is available to be selected and dispensed from the device;
the user selecting via a product selection means the cosmetics product which the user desires to be dispensed;
storing in a product storage means of the device the cosmetics product;
delivering to the user, via a product delivery means, the cosmetics product.

20. The method of claim 19, further comprising the steps of:
collecting data corresponding to the user's appearance via an appearance data collection means;
transmitting the data to an automatic product selection means; and
the automatic product selection means processing the data and automatically selecting the cosmetics product for delivery to the user.
